(19) United States
(12) Patent Application Publication
(10) Pub. No.: US 2006/0287834 A1
(43) Pub. Date: Dec. 21, 2006

(54) VIRTUAL MASS SPECTROMETRY

(76) Inventors: Paul Edward Kearney, Montreal, QC (CA); Kossi Lekpor, Vaudreuil-Dorion, QC (CA); Sajani Swamy, Cambridge (GB); Heather Butler, Monreal, QC (CA); Kevin Eng, Pierrefonds, QC (CA); Clive Hayward, Montreal, QC (CA); Joanna Hunter, Montreal, QC (CA); Gregory Opiteck, Montreal, QC (CA); Michael Schirm, Montreal, QC (CA)

Correspondence Address: TORYS LLP, 79 WELLINGTON ST. WEST, SUITE 3000, TORONTO, ON, M5K 1N2, CA

(21) Appl. No.: 11/424,736

(22) Filed: Jun. 16, 2006

Related U.S. Application Data
(60) Provisional application No. 60/691,414, filed on Jun. 16, 2005.

(51) Int. Cl. G06F 19/00

(52) U.S. Cl. 702/27

(57) ABSTRACT

Systems, methods, computer programming product, and databases for virtual mass spectrometry (VMS) enable the identification of polypeptides in samples without acquisition of MS/MS fragmentation spectra. Methods according to the invention employ databases containing records corresponding to polypeptides potentially present in samples. In addition to identifying polypeptides, such databases may be used for other purposes, including for example to correct experimental data, e.g., for analytical systemic errors.

### BACKGROUND OF THE INVENTION

Proteomics experiments aim to characterize proteins in samples of biological origin. Quantitative proteomics seeks to quantify and identify the differentially expressed proteins. Generally the proteins undergo some separation steps and are submitted to proteolytic digestion prior to analysis by mass spectrometry. Protein identification is a key component in the discovery of potential peptide or protein biomarkers of disease state or drug efficacy or other conditions.

Two methods for protein identification using mass spectrometry are peptide mass fingerprinting and tandem mass spectrometry (MS/MS). In the peptide mass fingerprinting approach a low complexity sample, typically consisting of a few proteins, is analyzed and the resulting mass spectrum searched against a database containing the complete proteome.

Tandem mass spectrometry, because of the specificity of the derived peptide fragmentation pattern, can be used to analyze a complex sample consisting of thousands of proteins while database searches are performed against complete proteomes. Protein identification for proteomic profiling of complex samples often relies on acquisition of MS/MS fragmentation spectra and matching of spectra to peptide/protein sequence data bases using software programs such as Mascot and Sequest.

The peptide sequence coverage and the comprehensiveness of protein identification provided by LC-MS/MS data is often limited due to peptide signal intensities that fall below the LC-MS limit of detection, peptides that are not intense enough for acquisition of a high quality MS/MS spectrum that can be used to determine the peptide sequence, or intense peptides which do not generate MS/MS spectra that are interpretable.

An additional constraint is the time and expense associated with comprehensive LC-MS/MS based protein identification in complex biological samples

One of the conclusions of the HUPO Plasma Proteome Project is that the development of fingerprinting methods is an avenue for improved protein identification in complex and clinically relevant samples such as plasma (Omenn, Gilbert S. et al, Proteomics, 5, 2005.).

There is a need for protein identification methods that do not rely on acquisition of MS/MS spectra and enable more comprehensive identification of LC-MS detectable peptides present in complex samples. Developments in the area of mass and chromatographic retention time based fingerprinting began with the evaluation of highly accurate mass measurements for mass fingerprinting (Conrads, Thomas P. et al., Analytical Chemistry, 72, 3349-3354, 2000) and has been extended to include two dimensional (mass and retention time) fingerprinting (Adkins, Joshua N. et al., Proteomics, 5, 3454-3466, 2005., Chen, Sharon S. et al., Journal of Proteome Research, 4, 2174-2184, 2005., Strittmatter, Eric F. et al., American Society for Mass Spectrometry, 14, 980-991, 2003, Smith, Richard D. et al., Proteomics, 2, 513-523, 2002.).

These methods often rely on historical databases, databases created empirically, that contain peptide charge, mass and retention time determined from LC-MS/MS data. Such historical databases have been searched with mass and retention times directly from LC-MS data for identification of proteins in a sample (Adkins, Joshua N. et al., Proteomics, 5, 3454-3466, 2005., Chen, Sharon S. et al., Journal of Proteome Research, 4, 2174-2184, 2005., Strittmatter, Eric F. et al., American Society for Mass Spectrometry, 14, 980-991, 2003, Smith, Richard D. et al., Proteomics, 2, 513-523, 2002.).

Historical databases have facilitated the identification of proteins present in complex samples based on LC-MS data, because this approach limits the database to peptides from proteins that are expected to be in the sample type used to generate the peptide query information by LC-MS, thereby limiting the size of the database. Limiting the size of the data base can reduce the number of false positive hits generated by the query to give higher confidence protein identifications. Furthermore, historical databases created from LC-MS/MS data restrict LC-MS based protein identification to peptides and proteins that can be identified via acquisition and matching of a MS/MS spectrum.

A major limitation of searching LC-MS/MS based reference databases with LC-MS derived data is that the results are not comprehensive in terms of proteins identified or peptide coverage. Mass fingerprinting has the potential to identify more proteins and with higher peptide coverage. However, this potential is nullified by the use of LC-MS/MS based reference databases. A second major limitation of the mass and mass and retention time fingerprinting methods currently used is that a database with one or two searchable peptide dimensions such as those known in the art, limits the feasibility of fingerprinting on a wide range of proteomic platforms because ultra-high mass accuracy is required to for confident protein identifications (Conrads 2000).

Searching using only one or two parameter fields results in high rates of false positive identifications, even when using a database limited to peptides identified by LC-MS/MS. This rate of false positive identifications is even higher when searching a more comprehensive database, for example a database created in silico that contains searchable fields (dimensions) for peptides from all proteins known to be expressed in a particular organism.

A method for accurate estimation of false positive rates of proteins identified by fingerprinting, that is broadly applicable to a range of fingerprinting methods, is needed both to assess feasibility of a particular fingerprinting search strategy and to rank the confidence level of the resulting protein identifications.

### SUMMARY OF THE INVENTION

The invention provides systems, methods, and computer programming product for a virtual mass spectrometry (VMS) that enable the identification of polypeptides in samples without acquisition of MS/MS fragmentation spectra. Such methods employ databases containing records corresponding to polypeptides potentially present in samples. In addition to identifying polypeptides, such database may be used for other purposes, including for example to correct experimental data, e.g., for analytical systemic errors.

For example, in one embodiment the invention provides a method for identifying polypeptides in a sample, the method including providing a target digestion fragment produced by contacting the sample with a protease, e.g., trypsin; acquiring reversed phase liquid chromatography (or other separation)/mass spectrometry data, e.g., a mass/charge ratio and chromatographic retention time (or other fraction), for the target digestion fragment; determining a mass of the target digestion fragment from the mass spectrometry data; and comparing the mass and the chromatographic retention time for the target digestion fragment with a database having a plurality of records, wherein each record corresponds to a reference digestion fragment and includes an identifier for the source polypeptide of the reference digestion fragment, the mass, and chromatographic retention time of the reference digestion fragment, wherein a match between the target digestion fragment and the reference digestion fragment identifies the polypeptide.

In various further embodiments, the experimental MS data may be subjected to mass correction or chromatographic retention time correction prior to being compared with the database. A wide variety of additional correction, false positive calculations, scoring, and filtering steps may be used in accordance with such methods. A number of such additional process steps are described herein.

In further aspects the invention provides methods, systems, and computer programming products for creating databases. An example of such a method includes providing sequence information for a plurality of source polypeptides; determining the digestion fragments produced from each source polypeptide in the plurality from digestion with a protease, e.g., trypsin; and creating a record for each digestion fragment, including an identifier for the source polypeptide, the mass, and chromatographic retention time of the digestion fragment (or other fraction).

In further aspects the invention provides methods, systems, and computer programming products for correcting mass and fraction entries in experimental MS data. An example of such a method includes providing a database as described herein and experimental MS data on a plurality of target digestion fragments, wherein the MS data includes the mass or mass/charge ratio of each target digestion fragment and the fraction containing the reference digestion fragment; matching two or more (e.g., at least 500) of the plurality of target digestion fragments with the corresponding reference digestion fragments in the database on the basis of mass; determining the offset between the experimental masses and the fraction of the target digestion fragments and the masses and the fraction for the corresponding reference digestion fragments in the database to calculate a mass correction factor and a fraction correction factor; and correcting the experimental masses and fractions of the target digestion fragments using the correction factors.

Such methods are suitable for use alone or in conjunction with other processes. For example methods according to this aspect of the invention are suitable for use in conjunction with the protein identification methods described herein.

The invention provides further methods, systems, and computer programming useful for identifying polypeptides in a sample. For example, such a method includes providing target digestion fragments by contacting a sample with a protease e.g., trypsin; separating the digestion fragments generated from the sample in to fractions using ion exchange chromatography (SCX); acquiring LC-MS data for each fraction comprised of mass/charge ratios and LC retention times of the digestion fragments detected; using the mass, retention time and SCX fraction of each digestion fragment detected to search a database comprised of records for protein digestion fragments wherein each record comprises at least an identifier for the source polypeptide, the sequence of the digestion protein, the mass of the digestion fragment, the retention time of the digestion fragment and the prediction elution fraction of the digestion fragment.

As a further example, such methods for identifying a polypeptide in a sample according to the invention include separating proteins in a complex sample using methods known in the art; providing target digestion fragments by contacting fractions, obtained by protein separation, with a protease e.g., trypsin; acquiring LC-MS data corresponding to each fraction comprised of mass/charge ratios and LC retention times of the digestion fragments detected; using the mass, retention time and protein separation fraction of each digestion fragment detected to search a database comprised of records for protein digestion fragments wherein each record comprises at least an identifier for the source polypeptide, the sequence of the digestion protein, the mass of the digestion fragment, the retention time of the digestion fragment and the prediction elution fraction of the source polypeptide.

In further aspects, the invention provides methods, systems, and computer programming useful for calculating false positive rates for protein identification based on simulated or actual VMS or other types of fingerprinting searches. Such methods include, for example, calculating a false positive rate (FPR) based on simulated randomized, iterative VMS searches and using the FPR calculated to identify low and high confidence protein identifications generated by a search using the same parameters as the FPR simulation. The invention also provides methods for calculating a dynamic false hit score based on the results of simulated or actual VMS searches and using this score to identify low or high confidence protein identifications in the search.

In various embodiments of the invention, the sample contains polypeptides from a single species of organism. A record in a database may also include another fraction, relative intensity, charge, or a coefficient indicative of the probability that a digestion fragment was digested from a specified source polypeptide for a specified sample. Digestion fragments included in a database of the invention may be produced by cleavage with a protease in silico.

By “polypeptide” is meant a chain of two or more amino acids, regardless of any post-translational modification (e.g., glycosylation or phosphorylation). Polypeptides may also be referred to as proteins or peptides herein. Source polypeptides are cleaved by the action of a protease into one or more digestion fragments.

By “digestion fragment” is meant a portion of a polypeptide produced, at least theoretically, by the action of a protease that reproducibly cleaves the polypeptide. Digestion fragment also means peptide precursor detected by LC-MS following digestion of a sample or fraction of a sample with a protease.

By “peptide” is meant a naturally occurring peptide or a peptide produced by digestion, a digestion fragment

By “source polypeptide” for a digestion fragment is meant the polypeptide from which a specified digestion fragment is at least theoretically produced by the action of a protease that reproducibly cleaves the source polypeptide. A source polypeptide contains at least two digestion fragments.

By “record” is meant all of the information provided for a polypeptide, e.g., digestion fragment, in a database. A record includes all fields for the polypeptide.

By “field” is meant a category of information for which data is provided in a record. Examples of fields include mass, chromatographic retention time, charge, intensity, and electrophoretic or other fraction (e.g., strong cation exchange elutions).

By an “entry” is meant a datum for a field for a particular polypeptide.

By “differentially expressed peptide” is meant a peptide that have been observed to have a differential abundance or intensity as determined by comparison of samples or groups of samples that represent different conditions, diseases, tissues, physiological states.

By “fraction” is meant a portion of a separation. A fraction may correspond to a volume of liquid collected during a defined time interval, for example, as in liquid chromatography (LC). A fraction may also correspond to a spatial location in a separation such as a band in a separation of a biomolecule facilitated by gel electrophoresis, e.g., SDS-PAGE. Furthermore, a fraction may correspond to an elution from a chromatography medium, e.g., strong cation exchange.

By “reference database” or “VMS database” is meant a plurality of records that correspond to a source polypeptide, a digestion fragment or peptide and data values associated with the digestion fragment/peptide or source polypeptide that can be determined empirically and searched against the database to identify peptides and source polypeptides.

By “retention time tolerance” it is meant the limits placed on the retention time.

By “searching a database” is matching data values represented in a query and corresponding to a peptide, ion, precursor, or digestion fragment and matching such values to similar values in records of a database, each record corresponding to a peptide or digestion fragment and a source polypeptide.

By “search parameters” is meant values that are considered in the search that limit the accuracy of the match between query data and a database record, such as a tolerance for matching each data type.

By “mass tolerance” it is meant the limits placed on the mass value.

By “post-translational modification (PTM)” it is meant the modification of proteins by the attachment of a chemical functional group. This occurs after protein synthesis in the cell and so is a natural occurrence. The PTM changes the mass of the polypeptide.

Other features and advantages of the invention will be apparent from the following description and the claims.

### BRIEF DESCRIPTION OF THE DRAWINGS

FIG. 1 is a histogram of the retention time offsets between the retention time prediction tool and actual retention times. This figure shows the fitting results obtained in training the RT prediction tool. Panel A. shows the fitting curve Obtained and panel B. show a histogram of the fitting error.

FIG. 2 illustrates the matching of query entries to peptides represented by records in the VMS database. The range of retention time values represented in the records of the VMS database are illustrated on the y axis; Max rt is the maximum retention time value of one or more records in the VMS database, min rt is the is the maximum retention time value of one or more records in the VMS database. Similarly in this figure the maximum and minimum mass values of all of the mass values in the data base are represented at the extreme ends of the x axis. The query point represents a match between a set of query data values corresponding to a digestion fragment or peptide and values for the same data types recorded in the database. The tolerance allowed for the match between the query data and the database data is represented by the red box where 2dmass is the tolerance allowed for matching mass values and 2drt is the tolerance allowed for matching retention time values. This illustrates graphically how increasing the rt and mass tolerance parameters for a given database search would lead to an increase false positive rate, relative to the same search performed with more stringent parameters or lower mass or retention time tolerances.

FIG. 3 illustrates a centralized Deployment Model for VMS searches. The reference database is maintained and updated at a central site (the server). Each client can submit a VMS query to the server and receive the VMS search results in response. Clients will have different proteomic equipment and procedures, in particular, LC-MS retention times and SDS-PAGE fraction molecular mass ranges will vary. However, by running standard mixtures of proteins (available from the central site), retention time conversions from the client LC system to the centralized VMS database can be established. Similarly, fraction conversions from the client SDS-PAGE procedure to the VMS database can be established a priori. This permits a central site to perform VMS protein identification for a broad range of clients with different proteomic platforms.

FIG. 4 shows results of the survey experiment (Example 2) where the reference database is the full human IPI database and fraction tolerance is set to 0.

FIG. 5 shows results of the survey experiment (Example 2) where the reference database has 5000 proteins and fraction tolerance is set to 0.

FIG. 6 illustrates the change in FDR (y-axis) as the number of proteins identified increases (x-axis), as mass tolerance increases (solid, dashed, dotted lines) and for two coverage thresholds (circles and squares). In this simulation fraction is not used for matching to the VMS database, and so, two dimensional fingerprinting (mass and retention time) is being assessed. The reference database is a random 5000 protein subset of the full human IPI database. Except for very small queries and very high mass accurary, the FDR is high (above 25%), even when searching a relatively small protein database. A search against a comprehensive database such as the complete human IPI database would be much higher. This illustrates the need for extending fingerprinting to 3 or more dimensions (such as mass, retention time and fraction) and the utility of predictive tools such as FDR for assessing the feasibility of protein identification searches.

FIG. 7 illustrates an application of VMS using 3 data types in the search (mass, rt, MW (SDS-PAGE band or fraction), the multidimensional fingerprinting model (MDF) (Example #). A comprehensive reference database is predicted directly from peptide and protein properties. Peptides from observed SDS-PAGE-LC-MS data were matched to peptides in the database based on a combination of peptide and protein properties including mass, retention time and molecular weight.

FIG. 8 MDS plot of all peptides detected in the human colon carcinoma study of 25 paired normal and tumor samples.

FIG. 9 Results of the VMS search using 2093 peptides over-expressed in tumor over normal. 331 proteins were identified with at least 4 hits from the same SDS-PAGE fraction.

### DETAILED DESCRIPTION OF THE INVENTION

Virtual Mass Spectrometry (VMS) is a technique that enables the identification of a polypeptide in a sample analyzed by mass spectrometry (MS), e.g., LC-MS, without the need for tandem mass spectrometry or other analytical techniques. VMS employs a database containing information on polypeptides, e.g., digestion fragments, to compare against experimental MS data. Matching experimental MS data with a record in the database identifies a polypeptide in a sample. VMS represents an improvement over traditional LC-MS/MS processes. In LC-MS/MS differentially expressed peptides, such as those identified using Constellation Mapping (WO 2004/049385) and a Mass Intensity Profiling System (US 2003/0129760; hereafter “MIPS”), hereby incorporated by reference, can be designated as targets. The sequence of the target (and thereby by identification of the polypeptide) is obtained through targeted LC-MS/MS, alignment, and Mascot search. In contrast, VMS allows for the direct identification of a polypeptide from the target without the need for tandem MS. VMS therefore provides the following advantages:

(1) VMS reduces or eliminates the need for LC-MS/MS, thereby reducing costs, enhancing throughput, and decreasing the amount of sample required,

(2) VMS reduces or eliminates the need for LC-MS to LC-MS/MS alignment and reliance on programs such as Mascot or Sequest for spectrum matching,

(3) VMS simplifies and automates the protein identification process,

(4) VMS improves the sensitivity of protein identification by identifying low intensity polypeptides that LC-MS/MS cannot.

As will be understood by those skilled in the relevant arts, methods and processes according to the invention are well adapted for implementation using automated mass spectrometry systems controlled at least partly by automatic data processors using automatic control scripts (e.g., batch processing) and/or whole or partial interactive control by a human user. Suitable controllers can comprise any data-acquisition and processing system(s) or device(s) suitable for accomplishing the purposes described herein. Controllers can comprise, for example, a suitably-programmed or -programmable general- or special-purpose computers, or other automatic data processing devices. Such controllers can be adapted, for example, for controlling suitable mass spectrometry devices in implementing and monitoring ion detection scans; and for acquiring and processing data representing such detections according to the various methods and processes disclosed herein. Accordingly, such controllers can comprise one or more automatic data processing chips adapted for automatic and/or interactive control by appropriately-coded structured programming, including one or more application and operating systems, and by any necessary or desirable volatile or persistent storage media. As will be understood by those of ordinary skill in the relevant arts, a wide variety of suitable processors and other mass spectrometry devices for implementing the invention are now available commercially, and will doubtless hereafter be developed.

Methods and processes in accordance with the invention are suitable for implementation on such equipment using any appropriate general- or special-purpose hardware, firmware and/or software, any of which may be provided with or in the form of computer programming media adapted to cause the one or more processors comprised by such system to perform the various disclosed herein, as for example electromagnetically-recorded compilations of programming structures written in any of a wide variety of suitable programming languages. Such programming languages can comprise, for example, any one or more of JAVA, any of the C variants, including C+ and C++, FORTRAN, COBOL, PASCAL, and BASIC. A wide variety of suitable languages are now available, and will doubtless hereafter be developed.

The VMS Database

The VMS database comprises data representing characteristics of polypeptide digestion fragments. For each digestion fragment there is accessible in the database data corresponding a reference to the polypeptide from which the fragment is derived (referred to as the parent polypeptide) as well as the sequence of the digestion fragment itself. In addition, there are data representing a number of measurements associated with each digestion fragment. These measurements may include, for example: neutral mass, chromatographic retention time (rt), isoelectric point (pI), preferred charge state, parent polypeptide molecular weight, hydrophobicity, separation fraction (e.g. SDS-PAGE or Strong Cation Exchange), the probability of the parent polypeptide being present in a sample and relative ionization efficiency (Gay, S. et al., 2(10), 1374-1391, 2002.).

The entries in a VMS database may be predicted and/or determined experimentally. For example, digestion fragment mass can be predicted directly from the digestion fragment sequence or determined experimentally by performing LC-MS/MS.

The parent polypeptides in a VMS database may be restricted to a species (e.g. human), organelle (e.g. plasma membrane), tissue (e.g. plasma), disease (e.g. oncology associated proteins), biological process (e.g. apoptosis), etc.

A VMS database may be limited to those parent polypeptides that can be detected on a particular technology such as SDS-PAGE or those digestion fragments that can be detected by a mass spectrometer. For example, digestion fragments may be excluded by size, hydrophobicity, charge or amino acid composition.

As will be understood by those skilled in the relevant arts, a wide variety of means may be used for creating, storing, accessing, searching, and modifying databases. Many such means exist, and doubtless others will be developed hereafter. A wide variety of such means are now available commercially, including, for example, spreadsheet products produced by Microsoft, Lotus, IBM, Sun, and other entities. Such products provide for the electromagnetic storage of data representing the various characteristics and information described herein, in volatile or permanent storage media, using suitable data recording protocols. Such records can comprise, for example, one or more data items or fields associated with one or more common addresses. Those skilled in the arts will not be troubled by the implementation of such databases in view of the disclosure herein.

Generating a VMS Database

To illustrate, the creation of a VMS database including data representing the following entries: parent polypeptide, digestion fragment, predicted digestion fragment mass, predicted digestion fragment retention time on LC-MS, and the predicted SDS-PAGE fraction of the parent polypeptide. This instantiation of a VMS database is created in 5 steps:

Step 1: Parent polypeptides are selected from a source. Examples of sources include the NCBI, Genpept, SwissProt, IPI databases or in-house generated sequences. All polypeptides from the sources may be included or a subset selected by species, organelle, tissue, disease, biological process, etc. Polypeptides that are not seen by SDS-PAGE can also be omitted.

Step 2: All selected parent polypeptides are theoretically digested by some enzyme such as Trypsin and the resulting digestion fragment sequences entered into the VMS database. In the case of Trypsin, it is know that the parent polypeptide is cleaved at the C terminus of every arginine and lysine. Additional rules can also be applied such as missed cleavages when a proline occurs on the C terminus side of an arginine or lysine. The set of digestion fragments can be reduced to those that are detectable on a mass spectrometer.

Step 3: For each digestion fragment, the theoretical mass is computed. To achieve this, the individual mass of each amino acid residue that composes the digestion fragment was added, plus the masses of the terminating groups: H at the N-terminus and OH at the C-terminus:
M_{fragment}=ΣM_{AA}+M_{H}+M_{OH}

If there are post-translational modifications (e.g. oxidation of methionine) then this can be incorporated by adjusting the mass of those digestion fragments containing methionine accordingly. If chemical modifications arise due to sample processing, for example due to the labeling of cysteines using ICAT technology, then these mass modifications can also be incorporated.

Step 4. For each digestion fragment, the theoretical chromatographic retention time (RT) is computed. The chromatographic retention time of a polypeptide may be predicted by methods known in the art based on the chromatographic separation being employed, e.g., reversed phase liquid chromatography (LC) or gas chromatography (GC), and the amino acid composition of the polypeptide.

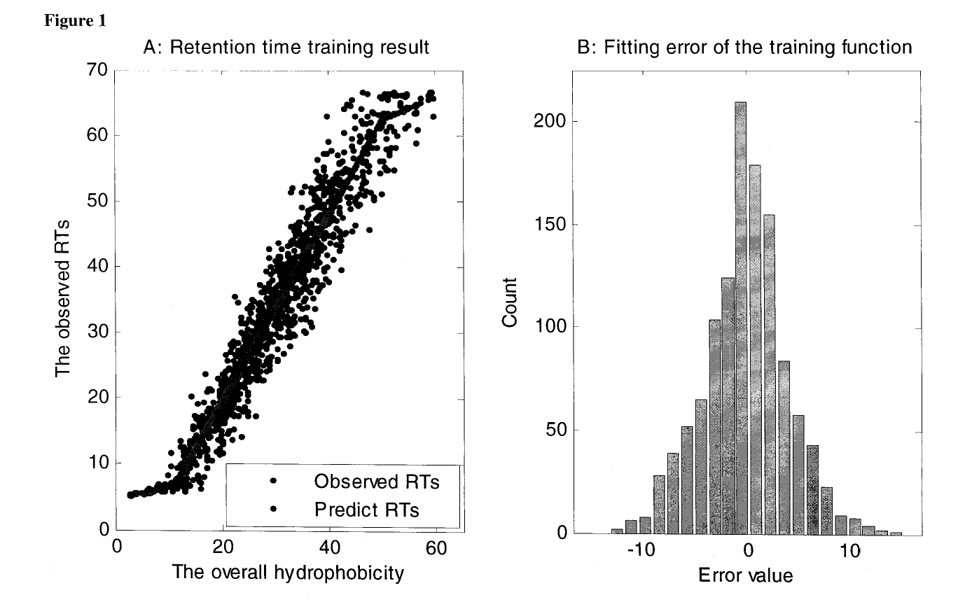

In one method, a linear relationship is assumed between the overall hydrophobicity of a peptide and its elution time on a reversed phase liquid chromatography column (Krokhin et al. Mol. & Cell. Proteomics, 2004 3:908-19). The process sums the retention coefficients of the individual amino acids that compose the peptide and then performs corrections on the resulting value based on properties of the peptide including length, amino acid composition at the N-terminal, and pI. The calculated value represents the overall hydrophobicity (Hphob) value of the peptide and is a property that does not depend on the stationary phase of the column. The method is then trained using experimental data to determine the values of a and b, which are required to predict the retention time using the equation:
RT=a*Hphob+b (FIG. 1A).

Given retention time data on a set of polypeptides run on a particular column, Constellation Mapping may be used to identify the polypeptides in data from a sample run on a different column for use in peptide retention time prediction on a different column, as long as the two columns have the same stationary phase. For example, peptides run on a 150-micron internal diameter (i.d.) column could be mapped to similar samples run on a 500-micron i.d. column. These data can then be used as a training set for retention time prediction.

To illustrate, we begin with a set of 1203 high confidence tryptic peptides from plasma, which have neither missed cleavages nor modifications. The observed retention time for these peptides ranged from 5.2 to 66.5 minutes. For each peptide in the set, the ‘overall hydrophobicity’ was calculated using the above retention time prediction tool. The observed RT of each sequence was plotted vs. its hydrophobicity value and a function fitting the correlation determined. The shape of the graph has a linear domain in the middle (ranged from 6.80 to 62.25 minutes) and two nonlinear domains at the extremities. Naturally, the middle section was fitted by a line, having a slope value of 1.4258 and an intersect value of −8.9621. The lower section was fitted by a Gaussian and the upper section by a logarithmic function. See FIG. 1.

Table 1 provides a reference to the accuracy of predicting the retention time of a given peptide sequence. It will be needed later in the process to determine the tolerance that can be applied on the retention time matching.

TABLE 1
Table of percentage of peptide covered vs. the error on RT prediction

| Error value | % Covered |
|---|---|
| ±1.0 min | 25.4 |
| ±2.5 min | 51.6 |
| ±5 min | 77.5 |
| ±7.5 min | 92.7 |
| ±10 min | 97.8 |
| ±15 min | 99.9 |

Step 5. For each polypeptide the SDS-PAGE fraction is predicted. Assuming a standard protocol for running a sample by SDS-PAGE with molecular weight markers and the cutting of the gel into n discrete bands or fractions, the fraction in which a polypeptide will occur can be determine from its molecular weight. Specifically, the molecular weight of the polypeptide in combination with the molecular weight markers that delineate the boundaries of the n fractions permit this prediction.

If there are post-translational modifications (e.g. phosphorylation, methylation) of the digestion fragments known either theoretically or emperically, these can be incorporated into the database by adding to the mass of those digestion fragments the mass of the modification. If chemical modifications arise due to sample processing (e.g. oxidation of methionine) then these mass modifications can also be considered in the calculation of values entered into database records. Modifications can also be considered in predicting the retention time or separation fraction of a digestion fragment.

Maintaining a VMS Database

Once a VMS Database has been created it can maintained in several ways. First, as the polypeptide source is updated (for example, polypeptides are added to the NCBI database) the VMS Database entries can be updated as well. Second, as samples are analyzed over time, by either VMS or LC-MS/MS, the VMS Database can be updated with observed data thereby increasing the accuracy of the database. This can occur in many ways:

As a digestion fragment is observed multiple times, its observed mass and observed retention time can be recorded. Eventually, multiple estimates of these values are formed. By applying the mean, median or some other statistical measure of centrality to these distributions results in a more accurate prediction of the digestion fragments mass and retention time. Similarly, the SDS-PAGE fraction for a polypeptide can be more accurately estimated.

Those digestion fragments that tend to ionize best for each polypeptide can be learned. As a result, an ionization ranking for each digestion fragment within a polypeptide can be determined.

Those polypeptides that are never or rarely identified can be determined. As a result, these polypeptides may be removed from the database.

Searching the VMS Database

The matching algorithm matches observed peptides from a LC-MS analysis to the digestion fragments in the VMS database. This procedure has the following components.

Query Formation

For each LC-MS sample analysis, peptide detection is performed where the monoisotopic mass and retention time of each peptide in the sample is determined. There are established methods for peptide detection. For each LC-MS sample analysis performed, mass calibration and/or retention time calibration can be performed using any number of established methodologies such as using internal standards. Though not the required for VMS, improved mass and retention time accuracy can improve the results of VMS searches. If multiple LC-MS sample analyses are performed, either on the same sample or on a collection of distinct samples (e.g. a study comparing healthy and diseased samples) then these samples can be grouped using hierarchical clustering on mass, retention time and fraction. The resulting peptide clusters provide multiple estimates of the same peptide. If desired, a consensus or composite peptide can be derived by determining the mean or median mass, retention time and fraction of the multiple estimates. For the duration we use the term peptide to mean either an original peptide or a composite peptide. A subset of all peptides may be selected for searching the VMS database. This selection can be performed in various ways, depending on the goals of the experiment. For example, in a comparison of healthy and diseased samples, those peptides differentially expressed (based on peptide intensity or abundance) may be selected for protein identification by VMS. We refer to the set of peptides selected as the VMS query. Each peptide in the query is defined by a unique identifier, mass, retention time and fraction.

Matching the VMS Query to the VMS Database:

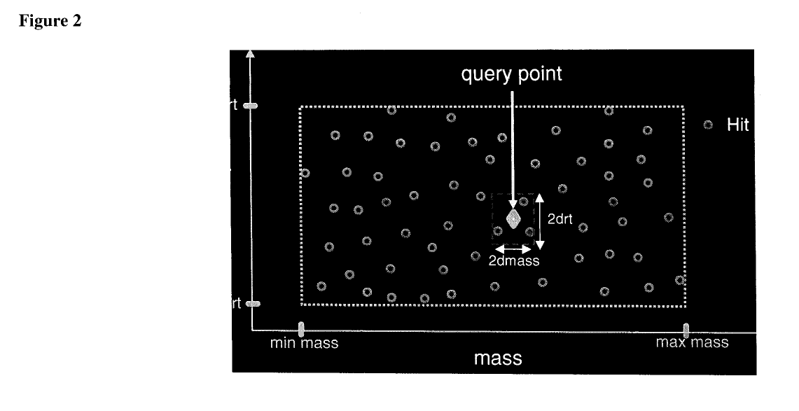

A VMS query is matched against the VMS database on mass, retention time and fraction illustrated by FIG. 2. Since matches will not be exact, matching is done to within specified tolerances. For example, the mass tolerance may be +/−10 ppm, the retention time tolerance +/−5 minutes and the fraction tolerance +/−1 fraction. Since the VMS database can be large (>10⁶ digestion fragments for the human proteome) and a VMS query also large (>10³ entries) then the VMS database can be indexed on mass or some other dimension for fast searching. The number of hits to a polypeptide is the number of distinct digestion fragments of the polypeptide matched to entries in the VMS query. The normalized hits to a polypeptide is the number of hits adjusted by the size of the polypeptide since the expectation is that larger polypeptides (i.e. those with more digestion fragments in the VMS database) will have more hits by chance alone. A parameter of the VMS search is the hit threshold: If a polypeptide has met or exceeded the hit threshold then the polypeptide is part of the set of identified polypeptides.

Determining the False Discovery Rate

A common measure for the efficiency of a protein identification procedure is to measure the rate of false positive protein identifications. A preferred methodology for estimating false positive rates, in general, is the False Discovery Rate (FDR) which, in the context of protein identification, is the expected number of false positives protein identifications divided by the total number of protein identifications.

Given a set of matching tolerances (mass, retention time, fraction) and a hit threshold, the set of identified polypeptides can be determined as described above. To determine the FDR, the following simulation is repeated a sufficient number of times to obtain a stable estimate:

Randomly select a set of digestion fragments from the VMS database equal in size to the VMS query.

Match the random VMS Query to the VMS Database using the same matching tolerances and hit threshold as for the original search.

Record the number of identified polypeptides.

The FDR is then the median number of polypeptides identified over these random trials divided by the number of polypeptides identified in the original search.

For increased specificity, the median number of identified polypeptides for each polypeptide size in the VMS database can be determined. This allows a FDR to be assigned to each identified polypeptide based on its size.

Parameter Optimization

Viewing the matching tolerances (mass, retention time, fraction) and hit threshold as variables in an optimization exercise where the goal is to maximize the number of identified polypeptides and minimize the FDR, an optimization procedure can be performed to determine the optimal or near-optimal parameters to use for the VMS search. To achieve this, various combinations of these parameters are used in a VMS Search and the FDR calculated for each. Whichever combination of parameters yields the best result (high number of identifications, low FDR) is used in the true VMS search.

Protein Ranking

After the list of identified polypeptides has been generated they can be ranked by hits, adjusted hits or size FDR or some function of these indicators. High confidence polypeptide identifications are then defined by a threshold such as a predefined FDR threshold.

Iterated VMS

VMS is described here as a one step protein identification procedure. However, there are advantages to iterating the VMS search. For example, after one VMS search, all peptides assigned to proteins identified with high ranking can be removed from the original VMS query. This results in a smaller query which can then be submitted for another VMS search. Because the query size decreases, the FDR will drop, as demonstrated by the survey presented below. This iterated approach was first introduced in the context of mass fingerprinting (Jensen, O. N. et al., Anal. Chem. 69, 4741-4750, 1997.). Furthermore, after all VMS searches have been completed, the reference database can be reduced to the list of proteins identified. This will be a much smaller database (100's of proteins versus 50 000), and so, PTMs, missed cleavages and non-tryptic peptides can be included. The remaining unassigned peptides from the VMS query can be searched against this smaller database to extend coverage on the previously identified proteins.

Deployment: Diversified Client Model

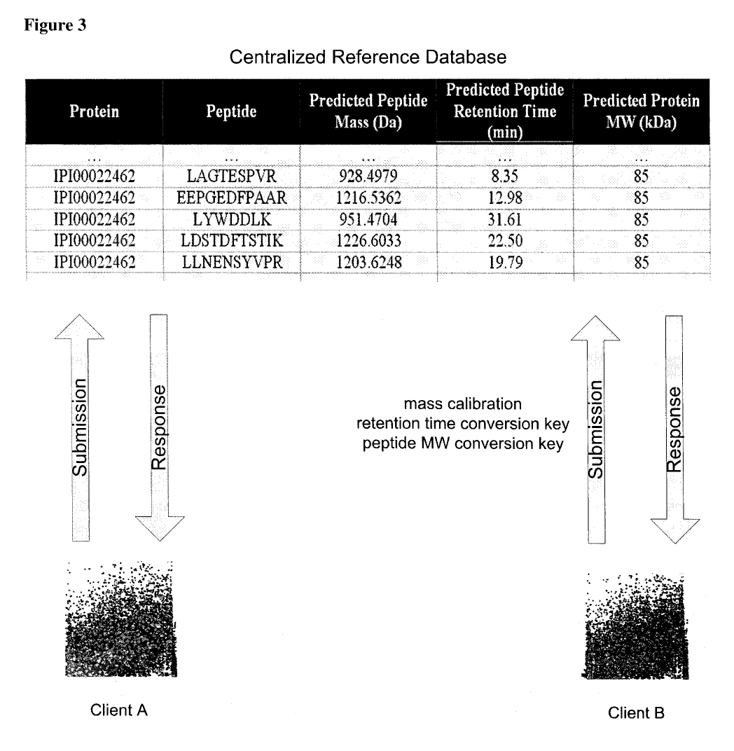

An emphasis of this paper is enabling VMS for wide use. In particular, VMS does not require ultra-high accuracy in any one dimension to be successful. Due to the comprehensive and predictive nature of the reference database, VMS as presented here can be maintained at a central site with VMS queries submitted from a diversified client base (FIG. 3.

The reference database is maintained and updated at a central site (the server). Each client can submit a VMS query to the server and receive the VMS search results in return. Since it is unreasonable to assume that clients will be using the same mass spectrometry equipment, LC systems and SDS-PAGE techniques, conversion keys are used. First, since mass is universally defined, each client performs their own mass calibration and specifies an appropriate mass matching tolerance for the VMS search. Second, the client analyzes by LC-MS a standard protein mixture (e.g. 8 proteins). This LC-MS analysis can then be correlated to the server's LC-MS analysis of the same standard protein mixture using LC-MS mass and retention time correlation algorithms such as Constellation Mapping (WO 2004/049385). This correlation can be described by a transformation function that maps peptide retention times from the client's LC system to the server's LC system. The client only needs to run the standard protein mixture analysis once. Third, the client can fractionate their SDS-PAGE gel into any number of fractions; however, they must use molecular weight markers on the gel in order to define a MW range for each observed peptide. This is a standard protocol.

The client-server deployment system has several advantages. The client does not need local expertise to perform protein identification; all reference database maintenance is conducted at a central location; the client does not require LC-MS/MS technology; searches from different labs can be performed by the same service thereby allowing comparability.

These techniques can be extended to other predictable peptide and/or protein dimensions.

Study Optimization Using FDR Methodology

As described above, the FDR can be used to optimize the VMS search parameters for a particular search. However, this methodology can be extended to adjust study design so that protein identification is optimized. This follows from the observation that the FDR calculation above depends only on the size of the VMS query. Explicit details of this methodology appear in Example 2 (Survey Experiment). Through simulation techniques, one can predict the FDR as the number of SDS-PAGE fractions is increased or decreased, as the size of the VMS query is increased or decreased and for different databases. For example, through study optimization using FDR, a user can determine, before conducting the experiment, how many SDS-PAGE fractions are required, limits on VMS query size and the largest VMS database to search.

Selection of Target Polypeptides

VMS may be used to identify polypeptides from any sample that may be analyzed by mass spectrometry. Selecting a polypeptide to identify by VMS (i.e., a target polypeptide) may occur on any basis, e.g., user selection and differential expression in two samples (e.g., healthy and normal). In one embodiment, a target polypeptide is identified by analysis using Constellation Mapping and MIPS.

Preferred samples include those that produce tryptic peptides. Virtually any biological sample is useful in the methods of the invention, including, without limitation, any solid or fluid sample obtained from, excreted by, or secreted by any living organism, including single-celled micro-organisms (such as bacteria and yeasts) and multicellular organisms (such as plants and animals, for instance a vertebrate or a mammal, and in particular a healthy or apparently healthy human subject or a human patient affected by a condition or disease to be diagnosed or investigated). A biological sample may be a biological fluid obtained from any location (such as blood, plasma, serum, urine, bile, cerebrospinal fluid, aqueous or vitreous humor, or any bodily secretion), an exudate (such as fluid obtained from an abscess or any other site of infection or inflammation), or fluid obtained from a joint (such as a normal joint or a joint affected by disease such as rheumatoid arthritis). Alternatively, a biological sample can be obtained from any organ or tissue (including a biopsy or autopsy specimen) or may comprise cells (whether primary cells or cultured cells) or medium conditioned by any cell, tissue, or organ. If desired, the biological sample is subjected to preliminary processing, including preliminary separation techniques. For example, cells or tissues can be extracted and subjected to subcellular fractionation for separate analysis of biomolecules in distinct subcellular fractions, e.g., polypeptides found in different parts of the cell. Such exemplary fractionation methods are described in De Duve ((1965) J. Theor. Biol. 6: 33-59).

A biological sample may also be purified to reduce the amount of any non-peptidic materials present. Moreover, if desired, polypeptides in samples are cleaved to produce digestion fragments for analysis. Cleavage is generally accomplished enzymatically, e.g., by digestion with trypsin, elastase, or chymotrypsin, or chemically, e.g., by cyanogen bromide. All samples that are to be compared typically are treated in the same manner.

A wide variety of techniques for separating biomolecules are well known to those skilled in the art (see, for example, Laemmli Nature 1970, 227:680-685; Washburn et al., Nat. Biotechnol. 2001, 19:242-7; Schagger et al., Anal. Biochem. 1991, 199:223-31) and may be employed prior to obtaining MS data. By way of example, mixtures of polypeptides may be separated on the basis of isoelectric point (e.g., by chromatofocusing or isoelectric focusing), of electrophoretic mobility (e.g., by non-denaturing electrophoresis or by electrophoresis in the presence of a denaturing agent such as urea or sodium dodecyl sulfate (SDS), with or without prior exposure to a reducing agent such as 2-mercaptoethanol or dithiothreitol), by chromatography, including LC, FPLC, and HPLC, on any suitable matrix (e.g., gel filtration chromatography, ion exchange chromatography (e.g., strong cation exchange), reverse phase chromatography, or affinity chromatography, for instance with an immobilized antibody or lectin or immunoglobins immobilized on magnetic beads), or by centrifugation (e.g., isopycnic centrifugation or velocity centrifugation). Mixtures of polypeptides may also be subjected to more than one form of separation, e.g., electrophoresis or strong cation exchange followed by LC. In any of the above embodiments, a given polypeptide may be present in more than one fraction depending on how the fractions were obtained.

Exemplary methods for analyzing polypeptides and other biomolecules using mass spectrometry techniques are well known in the art (see Godovac-Zimmermann et al. (2001) Mass Spectrom. Rev. 20: 1-57 (PMID: 10344271); Gygi et al. (2000) Proc. Natl. Acad. Sci. U.S.A. 97: 9390-9395 (PMID: 10920198); Reinders et al. 2004 Proteomics. 4: 3686-703; and Aebersold et al. 2003 Nature. 422: 198-207). The type of mass spectrometer is not critical to the methods disclosed herein.

Although the discussion herein is limited to polypeptides, the methods are generally applicable to any biological polymer, e.g., oligosaccharides and polysaccharides, lipids, nucleic acids, and metabolites, capable of being detected via mass spectrometry.

### EXAMPLE 1

### Spike Experiment

The goal of the spike experiment is to illustrate the sensitivity and specificity of VMS in the context of analyzing complex samples.

Methods

The spike experiment consisted of mixing eight (8) different proteins (Promix) and injecting the mixture into human plasma at different concentrations. The Promix proteins were from three different species (Saccharomyces cerevisiae (yeast), chicken and bovine (cow)) and were purchased from Michrom Bioresources (Auburn, Calif.). Before delivering, all proteins were reduced by dithiothreitol, alkylated by iodoacetamic acid, and digested by trypsin. The detail list of proteins that compose the Promix is summarized in Table 2. SP Accession in Table 2 refers to the Swiss Prot accession for the source polypeptide.

TABLE 2
The complete list of the 8 proteins spiked in human plasma.

| | Protein name | | GI | SP | IPI |
|---|---|---|---|---|---|
| Species | (Source Protein) | MW (KDa) | number | Accession | Accession |
| Chicken | Ovotransferrin (Conalbumin) | 77.758 | 1351295 | P02789 | IPI00683271 |
| Chicken | Lysozyme | 16.221 | 126608 | P00698 | IPI00600859 |
| Bovine | Carbonic Anhydrase | 28.968 | 115453 | P00921 | IPI00716246 |
| Bovine | Lactoperoxidase | 80.624 | 129823 | P80025 | IPI00716157 |
| Yeast | Alcohol Dehydrogenase | 36.805 | 1168350 | P00330 | |
| Yeast | Enolase | 46.784 | 119336 | P00924 | |
| Yeast | Hexokinase | 53.720 | 6321168 | P04806 | |
| Yeast | Phosphoglucose Isomerase | 61.281 | 6319673 | P12709 | |

The pooled human plasma standard was obtained from BioReclamation (New York, N.Y.). The plasma was depleted to remove the most abundant proteins using the Multiple Affinity Removal System™ (MARS) from Agilent Technologies (Palo Alto, Calif.).

For the LC-MS systems, solvents were supplied by a CapLC pumping system from Waters (Beverly, Mass.). Solution A was water/0.2% formic acid and solution B was acetonitrile/0.2% formic acid. Samples were injected onto a Jupiter C18 reversed phase column from Phenomenex (Torrance, Calif.). The gradient variation for the chromatographic separation was: 0-3 minutes: held at 10%; 3-60: linear increase from 10% to 34%; 60-62.5: step-like increase from 34% to 80%; 62.5:65: help at 80%; 65:75: linear decrease to 10%. A QToF Ultima from Waters (Manchester, UK) was used to acquire survey scans at the rate of 1 spectrum/second. The mass spectrometer acquisition range was limited from 400 to 1600 Da.

Raw data from the LC-MS runs were processed: (1) the raw MS peaks were smoothed; (2) isotopic peaks were detected; (3) then deisotoped to generate peptide peaks. Resulting peptide maps underwent Constellation Mapping (WO 2004/049385) analysis for reproducible peptides detection, followed by expression analysis using Mass Intensity Profiling (US 2003/129760) for selection of the differentially expressed peptides. The LC-MS data corresponding to differentially expressed peptides was used to generate a VMS query for which the following information was recorded: Peptide ID, SCX fraction, mass-to-charge ratio (m/z), retention time, charge and intensity.

The VMS processes described above were applied to the spike experiment data to assess VMS capability to identify the spike proteins in a complex sample (plasma). The query contained 2229 entries.

The VMS database contained all Bovine, Chicken and Yeast proteins from Swissprot combined with the HUPO PPP plasma proteome database. The mass tolerance was 15 ppm and the retention time tolerance was 6 minutes. The confidence level for the False Hit Rate was set to 0.0125 and the random search repetition rate was 100. The VMS run took 112 seconds on a Dell Dimension 9100 personal computer, equipped with Intel CPU 2.8 GHz and 1 GB of RAM. The operation system was Window XP Professional, Version 2002 with Service Package 2. The VMS functions were coded using Matlab® (The MathWorks, MA, USA) version 7.0.4 Release 14. A summary of the highest ranked VMS results is presented in Table 3. The FHR score in Table 3 is the False Hit Rate Score. This is a composite of hits (peptides in the query matched to that protein). Size is the number of potential peptide hits to a source polypeptide; Rank is a numbering of the proteins as they are sorted in the table; Cluster ID represents the outcome of homology clustering of the protein sequences identified based on at least 90% homology over 50% of the length of the sequences compared.

Results

VMS results with score above 0 are presented in Table 3 below.

TABLE 3
Summary of the VMS results on spike experiment data.

| Cluster | Protein | | | | | FHR | |
|---|---|---|---|---|---|---|---|
| ID | Accession | Protein Description | Rank | Score | Hits | score | Size |
| 3258 | P02789 | Ovotransferrin precursor | 1 | 19 | 27 | 8 | 47 |
| 227 | P00924 | Enolase 1 | 2 | 11 | 16 | 5 | 29 |
| 227 | P00925 | Enolase 2 | 2 | 5 | 10 | 5 | 28 |
| 3211 | P80025 | Lactoperoxidase precursor | 3 | 10 | 17 | 7 | 42 |
| 7533 | P00330 | Alcohol dehydrogenase 1 | 4 | 8 | 13 | 5 | 19 |
| 4526 | P12709 | Glucose-6-phosphate isomerase | 5 | 7 | 12 | 5 | 29 |
| 8969 | P00921 | Carbonic anhydrase 2 | 6 | 6 | 10 | 4 | 14 |
| 5425 | P04806 | Hexokinase-1 | 7 | 4 | 9 | 5 | 29 |
| 10863 | P00698 | Lysozyme C precursor | 8 | 3 | 6 | 3 | 10 |
| 7345 | P14540 | Fructose-bisphosphate aldolase | 9 | 3 | 7 | 4 | 17 |
| 9587 | P20433 | DNA-directed RNA polymerase II | 10 | 1 | 4 | 3 | 11 |
| 9237 | P00760 | Cationic trypsin precursor | 11 | 1 | 5 | 4 | 14 |
| 7534 | P00331 | Alcohol dehydrogenase 2 | 12 | 1 | 6 | 5 | 18 |
| 10980 | P02007 | Hemoglobin pi subunit | 13 | 1 | 4 | 3 | 12 |
| 7551 | Q9P4C2 | Alcohol dehydrogenase 2 | 14 | 1 | 6 | 5 | 21 |
| 5608 | P49872 | fructose-2,6-biphosphatase 1 | 15 | 1 | 7 | 6 | 36 |

The top eight proteins are the spiked proteins with score ranged from 3 to 19, and hits value from 6 to 27. The only other protein that was scored as high as one of the Promix proteins is Fructose-bisphosphate aldolase. This protein was also sequenced by targeted LC-MS/MS on the same samples which raises the possibility that Fructose-bisphosphate aldolase might be a contaminant. This result demonstrates the sensitivity and specificity of VMS.

### EXAMPLE 2

### Survey Experiment

A survey was conducted to explore the efficacy of VMS as key parameters of the VMS model were varied. These parameters included: mass tolerance, retention time tolerance, fraction tolerance, database size, number of proteins identified and coverage threshold. The measure of efficacy used is the FDR as estimated by the procedure defined above with 100 iterations.

The range of values for each of the search parameters applied were:

| Search Parameter | Values Applied |
|---|---|
| Mass tolerance (ppm): | (5, 10, 20) |
| Retention time tolerance | (7) |
| (min): | |
| Fraction tolerance (offset): | (0) |
| Database size (proteins): | (Human IPI database (57, 366 proteins |
| | and 1, 346, 200 peptides), 5000) |
| Proteins identified | (100, 200, 500, 1000, 2000, 3000) |
| (proteins): | |
| Coverage threshold (%): | (20, 30) |

For example, if the given set of parameters is [10 ppm, 7 min, 1 offset, 5000 proteins, 1000 proteins, 20%] then this means that observed peptides were matched to the VMS database to within +/−10 ppm mass, +/−7 min retention time, and +/−0 fraction. The VMS database contained 5000 proteins and the query included 20% of the peptides from each of 1000 proteins.

Methods

For each set of parameters assessed, a random set of “identified proteins” were selected from the VMS database, and for each of these proteins, a random set of peptides were selected to meet the coverage threshold. For example, if a protein with 45 peptides was selected and the coverage threshold parameter was 20% then 9 random peptides were selected from this protein. The set of all random peptides formed a VMS query. The size of the VMS query necessarily varied with the choice of proteins.

The VMS query was then submitted to the matching algorithm with the specified matching tolerances and coverage threshold. This results in the original set of randomly selected proteins being identified, but in addition, some number of false identifications that occur simply by chance. Hence, if the original set of randomly selected proteins had size 100, and 121 proteins met or surpassed the coverage threshold, then the estimated FDR would be (121−100)/121=21/121=17%.

To simulate protein identification on a database of 5000 proteins, a random subset of the Human IPI database was generated.

Note that homologies within the reference database present a technical problem. If an identified protein A is homologous to another protein B such that A and B are not differentiable by the available mass spectrometry data then B should not be considered a false positive identification. That is, the VMS approach itself is not the limiting factor but rather the incompleteness of the proteomic platform itself in not obtaining signals that differentiate the two proteins. Several approaches can be used to address this issue. For example, all identified proteins can be clustered using a tool such as BlastAll (NHGRI 2005 HTTP://GENOME.NHGRI.NIH.GOV/BLASTALL) to obtain a set of non-redundant clusters which is a better estimate of the number of unique identified proteins. For the purposes of the simulation, when the random VMS query is generated, all exact copies of these peptide sequences are eliminated from the reference database before the matching is performed to eliminate the possible bias of matching homologous proteins because of peptide sequence identity.

Results

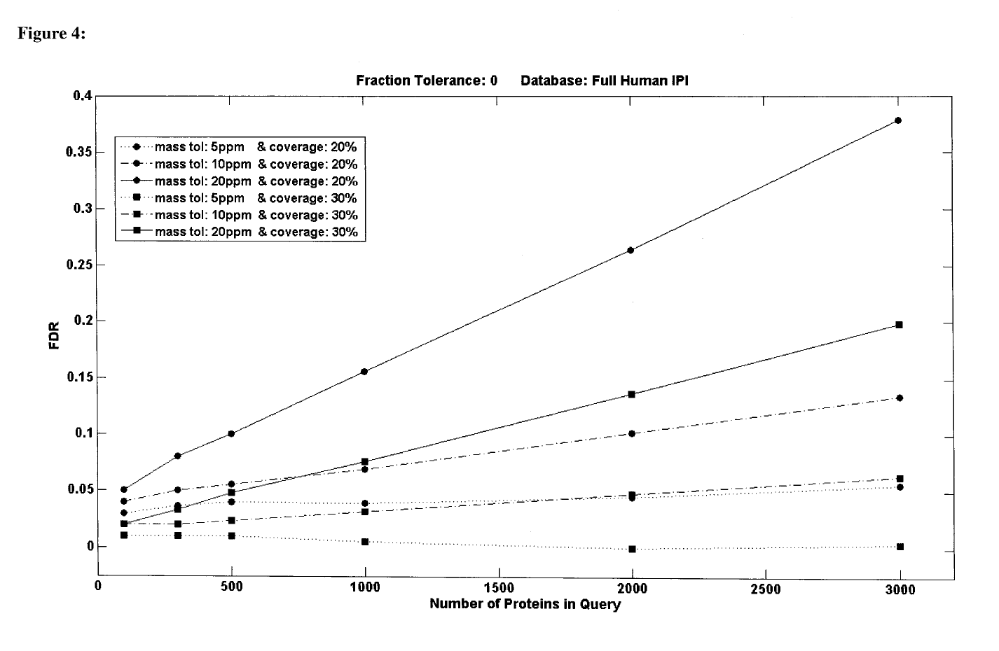

FIG. 4 illustrates the change in FDR (y-axis) as the number of proteins identified increases (x-axis), mass tolerance increases (solid, dashed, dotted lines) and for two coverage thresholds (circles and squares). The fraction tolerance is set to 0 and the reference database is the full human IPI database. Several trends can be observed in these results, for example, the dependence of FDR on mass accuracy and protein coverage. Most importantly, for 34 out of the 36 sets of parameters evaluated, the FDR was below 15% which is very reasonable.

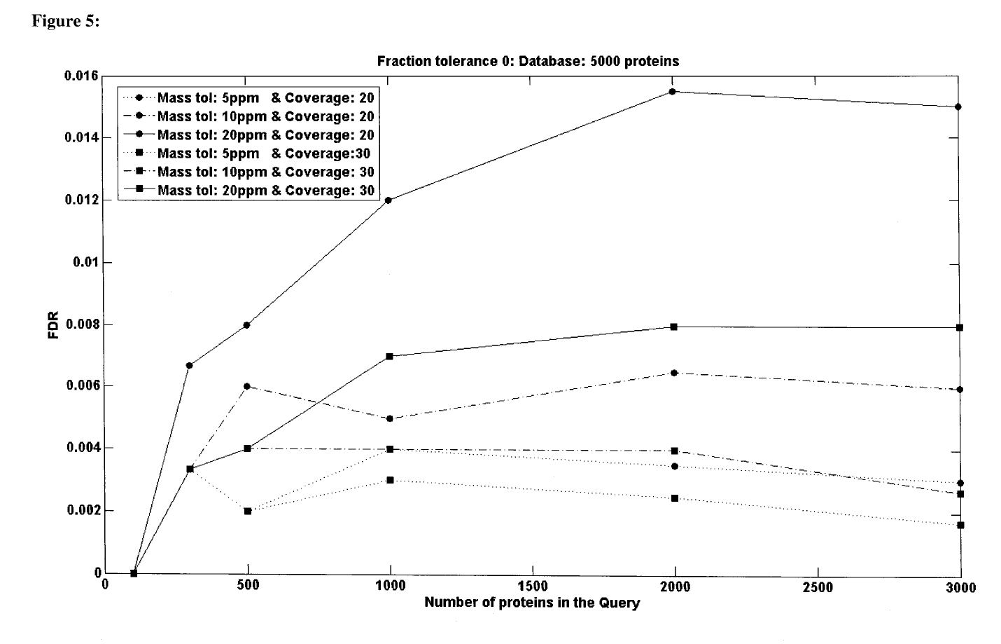

FIG. 5 illustrates the change in FDR (y-axis) as the number of proteins identified increases (x-axis), as mass tolerance increases (solid, dashed, dotted lines) and for two coverage thresholds (circles and squares). The fraction tolerance is set to 0 and the reference database is a random 5000 protein subset of the full human IPI database. Trends in this analysis are consistent with those presented for the full human database searches. Here, the FDR values are consistently small, never rising above 1.6% for any combination of parameter values.

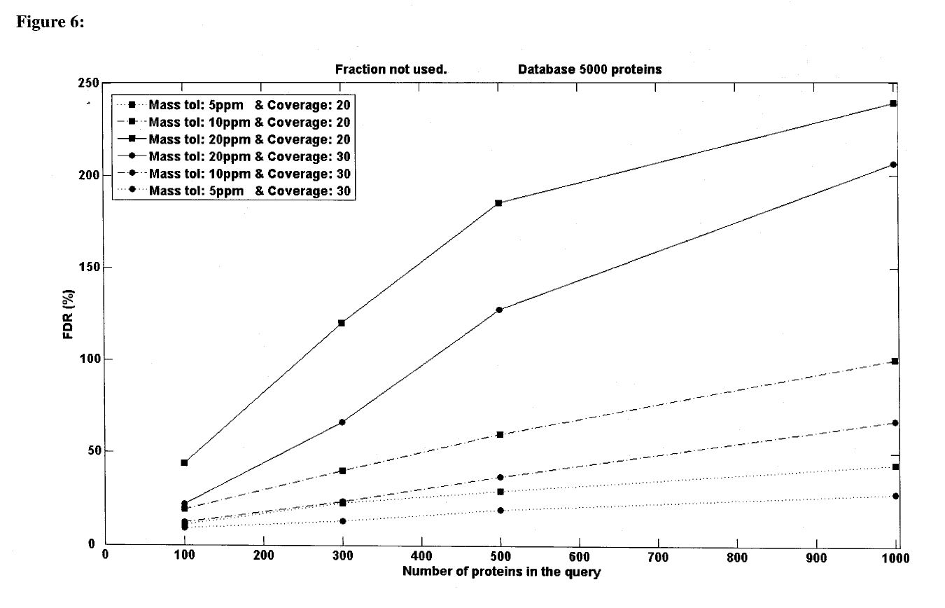

FIG. 6 illustrates the change in FDR (y-axis) as the number of proteins identified increases (x-axis), as mass tolerance increases (solid, dashed, dotted lines) and for two coverage thresholds (circles and squares). In this simulation fraction is not used for matching to the VMS database, and so, two dimensional fingerprinting (mass and retention time) is being assessed. The reference database is a random 5000 protein subset of the full human IPI database. Except for very small queries and very high mass accurary, the FDR is high (above 25%), even when searching a relatively small protein database. A search against a comprehensive database such as the complete human IPI database would be much higher. This illustrates the need for extending fingerprinting to 3 or more dimensions (such as mass, retention time and fraction) and the utility of predictive tools such as FDR for assessing the feasibility of protein identification searches.

### EXAMPLE 3

### Comprehensive VMS Protein Identification of Differentially Expressed Proteins in Human Colon Carcinoma

To enable fingerprinting on a wide range of proteomic platforms, three or more peptide dimensions can be used in a VMS search. Allowing for confident protein identifications, without the need for exceptionally high accuracy in LC-MS measures such as mass accuracy or retention time accuracy, based on large query sets (data representing more than 1000 peptides) and searches of databases that contain digestion fragments from a complete proteome such as the human proteome (representing as many as 50 000 proteins).

To assess the performance of VMS using 3 dimensions, searches of the entire human proteome as a reference database were executed. The three dimensions assessed are peptide mass, LC-MS retention time and protein MW (SDS-PAGE fraction). The database searched was comprised of source proteins representing the entire human proteome as defined by the IPI Human protein database, release 3.14 which contains 57, 366 proteins and 1, 346, 200 peptides. The False Discovery Rate (FDR) technique was applied to estimate the false positive protein identification rate (Benjamini, Y. et al. Journal of the Royal Statistical Society, Series B, 57, 289-300, 1995.). The FDR technique introduced here provides a rigorous methodology for evaluating the performance of VMS.

25 human colon carcinoma samples (normal and tumor tissue from the same patient) were analyzed by SDS-PAGE and LC-MS. Differential expression of peptides and proteins were accessed using Constellation Mapping and MIPS. Prior to expression analysis plasma membranes were purified using immuno-isolation methods, proteins were separation by SDS-PAGE into 24 fractions, proteins in each fraction were digested with trypsin followed by LC-MS based expression analysis. 331 differentially expressed proteins were identified by three dimensional fingerprinting with a FDR rate below 15%.

Methods

Patient tissue was obtained from the McGill University Hospital Center with Institutional Review Board approval and the informed consent of each donor. Colon tissue was obtained from each patient following resection of the colon, placed on ice, and macro-dissected at the hospital to obtain normal and tumor tissues, all within one hour of the surgery. Tumor mass was identified by the pathologist and excised from surrounding normal tissue. Normal epithelium was obtained from the same sample, distal to the tumor mass, by cutting it away from the connective and muscle tissue. Normal and tumor tissues were then processed immediately for dissociation to obtain single cell suspensions.

Tumor and normal cell samples were processed in parallel beginning with dissociation. Mouse Anti-ESA (ESA Ab-3, Neomarkers, cat # MS-181-P) and mouse anti-CEA (CEA Ab-3, cat # MS-613-P) antibodies were used for immuno-isolation of the plasma membrane. Plasma membrane enrichment was assessed by Western blot using plasma membrane specific markers CEA (1:600 dilution, Mouse anti-CEA Ab3, Neomarkers, catalog # MS-613-P) and sodium/potassium ATPase (1:96000 dilution, Mouse anti-Na+/K+ ATPase Alpha mAb, ABR, catalog # MA3-928) and contrasted to major intracellular organelles markers: nuclear marker H3; 1:100 dilution (Upstate Biotech, catalog #05-499), endoplasmic reticulum marker Bip; 1:400 dilution (BD Biosciences, catalog# 673320) and mitochondrial marker HSP60; 1:10000 dilution (Stressgen, catalog# SPA-806). The minimum acceptable enrichment of CEA and Na+/K+ ATPase was 2-fold.

Paired purified PM samples were loaded on a single 12% Bis-Tris NuPAGE gel (Invitrogen). Two normal and three tumor lanes were run on a single gel, separated by a lane of MW standards. Gels were run at constant voltage (10 min at 50V, then for approximately 60 min at 100V) until the dye front had migrated 3.0 cm from the bottom of the loading well. The gels were fixed for 30 min in 50% ethanol and 5% acetic acid followed by 10 min in 50% ethanol. Gel lanes were cut into 24 equal fractions of 1.25 mm, using a custom-designed cutter (The Gel Company). The proteins in the gel cubes were oxidized and digested with trypsin (Promega).

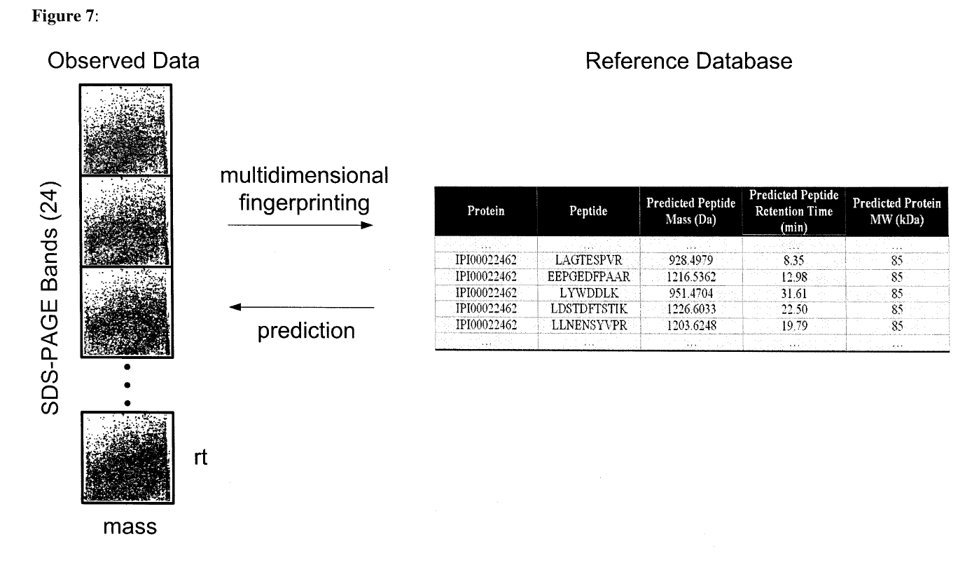

The VMS database searched was generated in silico from the non-redundant Human IPI database release 3.14 (Kersey P. J. et al. Proteomics 4(7), 1985-1988, 2004.). Fields of the reference database were protein accession, peptide sequence; predicted peptide mass, predicted peptide retention time and predicted protein molecular weight (see FIG. 7). For each protein in the database, all theoretical tryptic peptides were generated. Tryptic peptides that are too large or too small to be detected by were excluded. In addition, those peptides predicted to have missed cleavages such as those with an arginine or lysine followed by a proline were generated.

Mass is predicted directly from the peptide sequence by summing the amino acid masses and adding the mass of H₂O. The LC retention time of each peptide is predicted using a calibration set of high confidence LC-MS/MS peptides, a hydrophobicity prediction algorithm and then fitting the hydrophobicity predictions to the specific gradient of the LC system. As long as the LC system is not changed, the generation of this predictive model does not need to be repeated. A set of 1203 high confidence tryptic peptides sequenced by the LC-MS/MS analysis of pooled human plasma samples was submitted to an algorithm that generates an amino acid hydrophobicity model (Krokhin, O. V., Molecular and Cellular Proteomics, 3(9), 908-919, 2004.). The observed retention time of each sequence was then correlated to the predicted retention time of the hydrophobicity model and a correlation function derived. Protein molecular weight is predicted directly from the protein amino acid sequence. Assuming SDS-PAGE protein separation into 24 discrete fractions, the predicted fraction of each protein (and peptide) can be estimated using SDS-PAGE MW markers.

Each of the 24 gel fractions were sequentially analyzed by reverse phase capillary nano-liquid chromatography coupled with electrospray to a QTOF Ultima mass spectrometer (Waters). Each patient was analyzed independently with alternating injections of normal and tumor gel fractions to minimize intra-patient processing variation.

Data analysis included peptide detection; mass, retention time and intensity normalization; and hierarchical clustering of peptides by mass, retention time and fraction. Differentially expressed peptides between normal and tumor samples were selected using a paired T-test on the log ratio of tumor and normal patient samples, on a per fraction basis, at the 0.05 significance level. The resulting set of peptides is referred to as the target list.

A VMS query was formed from the target list and matched against the Human IPI reference database with mass, retention time and fraction tolerances of 20 ppm, 7 min and 0 fractions, respectively. Proteins were identified with at least 4 peptide matches to the VMS database and the FDR calculated as defined above

Results

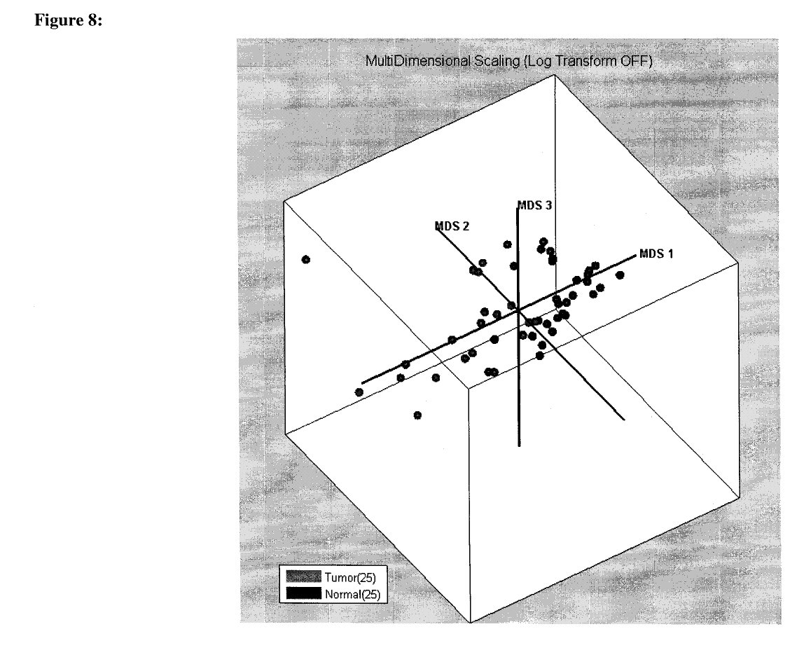

A Multidimensional Scaling (MDS) analysis of all peptides detected in the 25 patient human colon carcinoma study of paired normal and tumor samples appears in FIG. 8. MDS is an unsupervised clustering tool that gives a global perspective on the similarity of 50 samples. This illustrates, on a global level, that significant differences exist between the normal and disease populations.

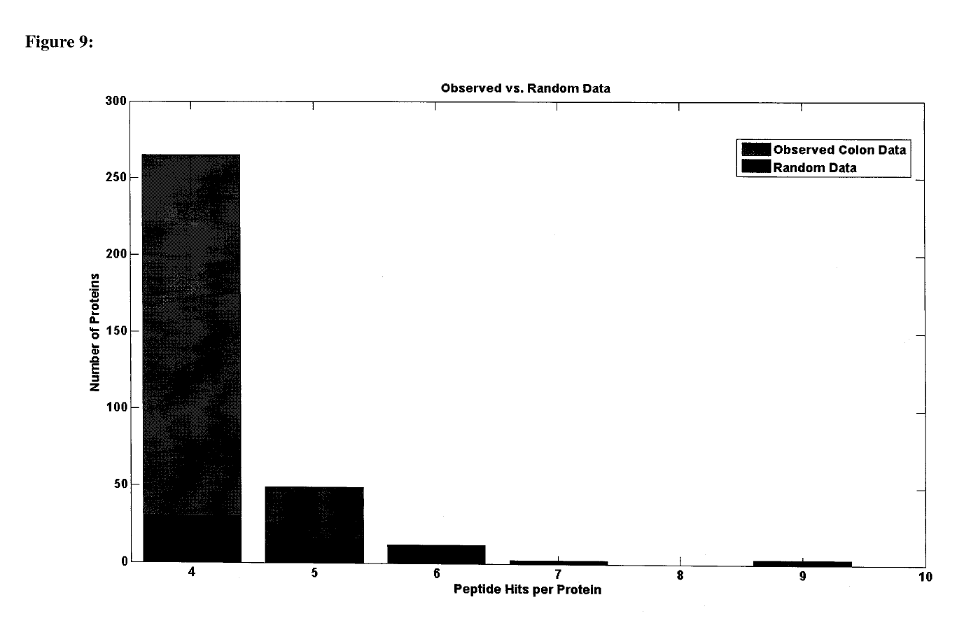

2093 peptides over-expressed in tumor over normal samples were found using the paired T-test on the log ratio of the 25 tumor and normal patient pairs at significance 0.05. A query representing all 2039 over-expressed peptides was submitted to a VMS search using the following parameters: 20 ppm, 7 min and 0 fraction tolerances for mass, retention time and SDS-PAGE fraction and with at least 4 peptide hits in the same fraction resulted in 331 proteins (FIG. 9). The FDR, as calculated by the procedure described herein, is 14.9%+/−3.6%.

### Other Embodiments

The description of the specific embodiments of the invention is presented for the purposes of illustration. It is not intended to be exhaustive or to limit the scope of the invention to the specific forms described herein. Although the invention has been described with reference to several embodiments, it will be understood by one of ordinary skill in the art that various modifications can be made without departing from the spirit and the scope of the invention, as set forth in the claims. Except to the extent necessary or inherent in the processes themselves, no particular order to steps or stages of methods or processes described in this disclosure, including the Figures, is intended or implied. In many cases the order of process steps may be varied without changing the purpose, effect, or import of the methods described.

All patents, patent applications, and publications referenced herein are hereby incorporated by reference.

Other embodiments are in the claims.

What is claimed is:

1. A method for identifying polypeptides in a sample or set of samples, the method comprising:
a. separating proteins in a sample and collecting sample fractions
b. producing a plurality of digestion fragments by contacting each fraction of the sample with a protease;
c. acquiring LC-MS data for each fraction, the data comprising at least a mass-to-charge ratio, a retention time, and a signal intensity corresponding to each digestion fragment;
d. generating a database query comprising values corresponding to a plurality of digestion fragments for which mass spectrographic data has been acquired, the values representing the mass-to-charge ratio and retention time for the digestion fragment, and the separation fraction from which the respective digestion fragments were collected;
e. using the query, searching a database comprising records corresponding to digestion fragments, wherein each record comprises at least an identifier for a source polypeptide associated with the digestion fragment, the sequence of the digestion fragment, the mass of the digestion fragment, the retention time of the digestion fragment, and the separation fraction of the digestion fragment to identify source proteins based on a match between the digestion fragment data represented in the query and in the database

2. The method of claim 1, where the sample is a complex biological sample.

3. The method of claim 1, where the protease is trypsin class protease.

4. The method of claim 1, wherein separating proteins in a sample and collecting sample fractions comprises using SDS-PAGE

5. The method of claim 4, where separating the digested sample is performed using cation exchange chromatography.

6. The method of claim 4, where separating the digested sample is performed using anion exchange chromatography.

7. The method of claim 4, where separating the digested sample is performed using hydrophobic interaction chromatography.

8. The method of claim 4, where separating the digested sample is performed using size exclusion chromatography.

9. The method of claim 1, where separating the digested sample is performed using immuno-affinity isolation of proteins.

10. The method of claim 1, where at least one thousand digestion fragments are detected.

11. The method of claim 1, where the LC-MS includes multiple LC-MS analyses of a plurality of fractions.

12. The method of claim 1, wherein the database query comprises values acquired using LC-MS analysis of multiple samples.

13. The method of claim 13, wherein the samples comprise replicates of the same fraction.

14. The method of claim 14, wherein the samples comprise multiple samples representing a condition.

15. The method of claim 15, wherein the condition comprises a disease.

16. The method of claim 1, wherein the database query comprises values acquired through analysis of differentially expressed digestion fragments.

17. The method of claim 17, wherein the selection of data for generating a query is based on a comparison of intensities across multiple samples of a sample set.

18. The method of claim 1, wherein the database query comprises values corresponding to at least 50,000 source polypeptides.

19. The method of claim 1, wherein the database comprises at least one record in which values representing at least one of a mass, a retention time, and a separation fraction of a digestion fragment of a corresponding digestion fragment is predicted.

20. The method of claim 1, wherein the database records contain only predicted values representing mass, a retention time, and a separation fraction of a digestion fragment of a corresponding digestion fragment

21. The method of claim 21, wherein the prediction of retention time is based at least in part on prediction of the hydrophobicity of peptides.

22. The method of claim 1, comprising calculating a false positive rate (FPR) based on at least one simulated search of a database, and using the FPR to select at least one parameter or tolerance applied to the database search.

23. The method of claim 23, wherein the simulated search is based at least partly on randomly-provided data.

24. The method of claim 24, wherein the simulated search is based at least part on interactively-input data.

25. The method of claim 1, comprising calculating a false positive rate (FPR) based on at least one simulated search of a database, and using the FPR to identify at least one low-confidence protein identification.

26. The method of claim 26, wherein the simulated search is based at least partly on randomly-provided data.

27. The method of claim 26, wherein the simulated search is based at least part on interactively-input data.

28. The method of claim 1, comprising calculating a dynamic false hit (DFH) score and using the DFH score to identify at least one low-confidence protein identification.

29. The method of claim 1, wherein the database comprises at least one record comprising data corresponding to a naturally-occurring peptide.

30. The method of claim 1, wherein the database comprises at least one record in which at least one mass is calculated to include the mass of a post translational modification of the digestion fragment.

31. The method of claim 1, wherein the database comprises at least one record in which at least one mass is calculated to include the mass of a chemical modification of the digestion fragment.

32. The method of claim 1, wherein the database comprises at least one record in which at least one retention time is calculated to include the mass of a post translational modification of the digestion fragment.

33. The method of claim 1, wherein the database comprises at least one record in which at least one retention time is calculated to include the mass of a chemical modification of the digestion fragment.

34. The method of claim 1, wherein the database comprises records corresponding solely to peptides detectable by the mass spectrographic method used in the acquiring data for each fraction.

35. The method of claim 1, wherein the database comprises records corresponding only to peptides that contain less than 6 and more than 35 residues. Check limits in spec

36. The method of claim 1, wherein the database comprises records corresponding only to peptides have a mass less than 4500 Da.

37. The method of claim 1, wherein the database query comprises values derived from a charge determined using mass spectrometry.

38. The method of claim 1, wherein the database query comprises values derived from an ionization rank determined using mass spectrometry.

39. The method of claim 1, wherein the database comprises records including data derived from a charge determined by mass spectrometry.

40. The method of claim 1, wherein the database comprises records including data derived from an ionization rank determined using mass spectrometry.

41. The method of claim 1, wherein the database comprises at least one record corresponding to a source polypeptide corresponding to a complete proteome of a particular species, organism, organelle, tissue or bodily fluid.

42. The method of claim 1, wherein the database comprises records corresponding to substantially all digestion fragments that can be generated from each of the source polypeptides represented by data in the database.

43. The method of claim 1, wherein the database searched is located on a centralized server and queries generated in a different location and submitted to the central sever.

44. The method of claim 1, wherein the database searched is located on a centralized server and queries are generated by programs on the central server and LC-MS data is submitted to the central server.

45. A method for identifying polypeptides in a sample or set of samples, the method comprising:
a. producing a plurality of digestion fragments by contacting a sample with a protease;
b. separating the digested sample and collecting fractions;
c. acquiring LC-MS data for each fraction, the data comprising at least a mass-to-charge ratio, a retention time, and a signal intensity corresponding to each digestion fragment;
d. generating a database query comprising values corresponding to a plurality of digestion fragments for which mass spectrographic data has been acquired, the values representing the mass-to-charge ratio and retention time for the digestion fragment, and the separation fraction from which the respective digestion fragments were collected;
e. using the query, searching a database comprising records corresponding to digestion fragments, wherein each record comprises at least an identifier for a source polypeptide associated with the digestion fragment, the sequence of the digestion fragment, the mass of the digestion fragment, the retention time of the digestion fragment, and the separation fraction of the digestion fragment to identify source proteins based on a match between the digestion fragment data represented in the query and in the database.

46. The method of claim 1, where separating the digested sample is performed using chromatography.

47. The method of claim 4, where separating the digested sample is performed using cation exchange chromatography.

48. The method of claim 4, where separating the digested sample is performed using anion exchange chromatography.

49. The method of claim 4, where separating the digested sample is performed using hydrophobic interaction chromatography.

50. The method of claim 4, where separating the digested sample is performed using size exclusion chromatography.

51. The method of claim 1, where separating the digested sample is performed using immuno-affinity isolation of peptides.

52. A method for identifying polypeptides in a sample or set of samples, the method comprising:
a. producing a plurality of digestion fragments by contacting each fraction of a sample with a protease;
b. acquiring LC-MS data for each fraction, the data comprising at least a mass-to-charge ratio, a retention time, and a signal intensity corresponding to each digestion fragment;
c. generating a database query comprising values corresponding to a plurality of digestion fragments for which mass spectrographic data has been acquired, the values representing the mass-to-charge ratio and retention time for the digestion fragment;
d. using the query, searching a database comprising records corresponding to digestion fragments, wherein each record comprises at least an identifier for a source polypeptide associated with the digestion fragment, the sequence of the digestion fragment, the mass of the digestion fragment, the retention time of the digestion fragment, and the separation fraction of the digestion fragment to identify source proteins based on a match between the digestion fragment data represented in the query and in the database; and
e. calculating a false positive rate (FPR) based on at least one simulated search of a database, and using the FPR to identify at least one low-confidence protein identification.

53. The method of claim 45, comprising using the FPR to at least one parameter or tolerance applied to the database search.

54. The method of claim 45, wherein the simulated search is based at least partly on randomly-provided data.

55. The method of claim 45, wherein the simulated search is based at least part on interactively-input data.

56. The method of claim 45 comprising calculating a dynamic false hit (DFH) score and using the DFH score to identify at least one low-confidence protein identification.

57. The method of claim 45 comprising calculating a dynamic false hit (DFH) score and using the DFH score to identify at least one low-confidence protein identification.

58. A method for creating a database, said method comprising the steps of:
a. providing sequence information for a plurality of source polypeptides;
b. using mass spectrometry, determining digestion fragments produced from each source polypeptide in said plurality from digestion with a protease;
c. creating a database comprising a data record corresponding to each digestion fragment, wherein each record comprises data representing at least an identifier for a source polypeptide associated with the digestion fragment, a sequence of the digestion fragment, a mass of the digestion fragment, and a retention time of the digestion fragment;
d. using a query comprising values corresponding to a plurality of digestion fragments for which data records have been created, the values representing the mass-to-charge ratios and retention times for the corresponding digestion fragments, searching the database;
e. as a result of said search, identifying source proteins based on a match between the digestion fragment data represented in the query and in the database; and
f. adding to the data base records comprising empirically determined data relating to the digestion fragments to annotate the database.

59. A system useful for identifying polypeptides in a sample or set of samples, the system comprising at least one data processor, and computer programming media adapted to cause the at least one data processor to:
a. generate a database query comprising values corresponding to a plurality of digestion fragments for which mass spectrographic data has been acquired, the mass spectrographic data comprising at least a mass-to-charge ratio, a retention time, and a signal intensity corresponding to each of a plurality of digestion fragments and the values representing mass-to-charge ratios and retention times for at least one digestion fragment, and a separation fraction from which the respective at least one digestion fragment was collected; and
b. using the query, search a database comprising records corresponding to digestion fragments, wherein each record comprises at least an identifier for a source polypeptide associated with the digestion fragment, the sequence of the digestion fragment, the mass of the digestion fragment, the retention time of the digestion fragment, and the separation fraction of the digestion fragment to identify source proteins based on a match between the digestion fragment data represented in the query and in the database.

60. The system of claim 52, wherein the computer programming is further adapted to cause the at least one data processor to calculate a false positive rate (FPR) based on at least one simulated search of a database, and using the FPR, identify at least one low-confidence protein identification.

61. Computer programming media adapted for causing a data processor to:
a. generate a database query comprising values corresponding to a plurality of digestion fragments for which mass spectrographic data has been acquired, the mass spectrographic data comprising at least a mass-to-charge ratio, a retention time, and a signal intensity corresponding to each of a plurality of digestion fragments and the values representing mass-to-charge ratios and retention times for at least one digestion fragment, and a separation fraction from which the respective at least one digestion fragment was collected; and
b. using the query, search a database comprising records corresponding to digestion fragments, wherein each record comprises at least an identifier for a source polypeptide associated with the digestion fragment, the sequence of the digestion fragment, the mass of the digestion fragment, the retention time of the digestion fragment, and the separation fraction of the digestion fragment to identify source proteins based on a match between the digestion fragment data represented in the query and in the database.

62. The media of claim 54, further adapted to cause the at least a data processor to calculate a false positive rate (FPR) based on at least one simulated search of a database, and using the FPR, identify at least one low-confidence protein identification.

63. A system useful for identifying polypeptides in a sample or set of samples, the system comprising at least one data processor, and computer programming media adapted to cause the at least one data processor to:
a. access a database comprising a data record corresponding to characteristics of a plurality of digestion fragments determined by mass spectrography, wherein each record comprises data representing at least: an identifier for a source polypeptide associated with the respective digestion fragment, and a sequence, a mass, and a retention time of the respective digestion fragment;
b. using a query comprising values corresponding to a plurality of digestion fragments for which data records have been created, the values representing the mass-to-charge ratios and retention times for the corresponding digestion fragments, to search the database;
c. as a result of said search, identify source proteins based on a match between the digestion fragment data represented in the query and in the database; and
d. add to the data base records comprising empirically determined data relating to the digestion fragments to annotate the database;

64. Computer programming media adapted for causing a data processor to:
a. access a database comprising a data record corresponding to characteristics of a plurality of digestion fragments determined by mass spectrography, wherein each record comprises data representing at least: an identifier for a source polypeptide associated with the respective digestion fragment, and a sequence, a mass, and a retention time of the respective digestion fragment;
b. using a query comprising values corresponding to a plurality of digestion fragments for which data records have been created, the values representing the mass-to-charge ratios and retention times for the corresponding digestion fragments, to search the database;
c. as a result of said search, identify source proteins based on a match between the digestion fragment data represented in the query and in the database; and
d. add to the data base records comprising empirically determined data relating to the digestion fragments to annotate the database;
